(19) United States
(12) Patent Application Publication
(10) Pub. No.: US 2005/0097801 A1
(43) Pub. Date: May 12, 2005

(54) Business card holder

(76) Inventors: Suil Kang, Atlanta, GA (US); Harry I. Leon, Atlanta, GA (US)

Correspondence Address: Mr. Harry I Leon, 924 Bowen Street, N.W., Atlanta, GA, 30318, US

(21) Appl. No.: 10/712,730

(22) Filed: Nov. 12, 2003

(51) Int. Cl. G09F 3/18; B42F 5/00

(52) U.S. Cl. 40/661; 40/405

(57) ABSTRACT

A device for storing and organizing business cards. The device comprises a loop such as a ring and a plurality of protective members, each member defining a hole and comprising two sheets of plastic material. A business card is inserted in the space formed between the two sheets of plastic material either before or after the protective member is retained on the loop. The present invention facilitates the management and access of a plethora of business cards.

### FIELD OF THE INVENTION

This invention relates generally to devices and methods for facilitating the organization and storage of planar goods, such as business cards, name cards, credit cards, and the like.

### BACKGROUND OF THE INVENTION

The use of business or name cards (hereinafter “business cards”) is ubiquitous and wide-spread. Any entities, including companies, enterprises, and individuals (hereinafter “entities”) can easily make business cards and distribute them to its customers, acquaintances, and others to succinctly convey essential contact information. Business cards are a fact of modern life, and for any entities, it is important to be able to keep track of numerous business cards and be able to easily and quickly retrieve a particular business card.

There are numerous electronic devices designed to allow easy retrieval of the information one receives via a business card. The use of the electronic devices requires one to type or enter the information written on a business card on to an electronic storage device. Many times information on a particular business card may not be useful to the recipient thereof. In such a case, it is inefficient to type or enter the information on a business into an electronic device. In addition, the operation of electronic devices can fail depending on a variety of factors and cannot replace the printed form of ordinary business cards.

There are also numerous non-electronic methods and devices for storing and organizing the business cards, including such as the use of a ROLADEX® index card system and a notebook having divided and protective plastic sheets. For example, U.S. Pat. No. 4,849,056 to Ristuccia, Sr. discloses adapting a ROLADEX® index card system to store a business card. These conventional methods, however, are cumbersome to use and do not facilitate easy organization, storage, and access of the information on a number of business cards. As an example, when a business card is attached to an index card in a ROLADEX® system, the index card system becomes bulky. As another example, when a notebook having a plurality of divided plastic sheets is used, one needs to re-arrange the business cards as she accumulates more cards, because it is often the case that one acquires a business card that needs to be placed between two business cards placed contiguously without an additional space between them.

The present invention overcomes disadvantages of the prior art devices and methods for storing, organizing and accessing a plurality of business cards.

### SUMMARY

The present invention provides a holder for business cards, comprising a loop and a protective element defining a hole. In the preferred embodiment, the loop can be adaptively open or closed, and the protective member can attach or hang from, or retained on the loop. Typically, the protective element comprises two sheets of plastic joined together so as to provide a covering to a planar item, such as a business card. The protective element may define a slit or an opening that can be adaptively opened or closed so that a business card can be inserted into the space formed by the two sheets of plastic. In the preferred embodiment, the plastic sheets are transparent, so that the users thereof can read information on the planar item enclosed therein. However, the plastic member can also be tinted with various colors. In general, the protective member is rectangular, but it can be square or other desired shapes.

The loop is generally circular but it can be any shape as long as it forms a loop from which a protective member can hang. The loop can be made of metal, plastic and other material. For example, the loop may be a large metal ring with two abutted ends, which ends can be pulled apart so that one of the ends can be slid into the hole defined by the protective member. In another embodiment, the loop can be a ring that comprises a groove, a catch and a lever. The user opens the ring manipulating the lever, which unlocks the catch from the groove. The user then slides one end of the ring through the hole of the protective member and locks the ring by manipulating the lever. When the ring is locked, the catch rests within the corresponding groove and the lever is in a resting position. Any open-and-close means can be used to allow users of the present invention to manipulate the loop and adaptively open and close the loop.

### BRIEF DESCRIPTION OF THE DRAWINGS

FIG. 1 is a first embodiment of the present invention.

FIG. 2 illustrates loop 11 having two abutting ends.

FIG. 3 shows another embodiment for loop 11.

FIGS. 4a and 4b show still different embodiments for loop 11.

FIG. 5 shows a first embodiment for protective member 12.

FIG. 6 shows another embodiment for protective member 12.

FIGS. 7a and 7b show still different embodiments for protective member 12.

FIG. 8 illustrates a board accommodating a plurality of devices shown in FIG. 1.

### DETAILED DESCRIPTION OF THE INVENTION

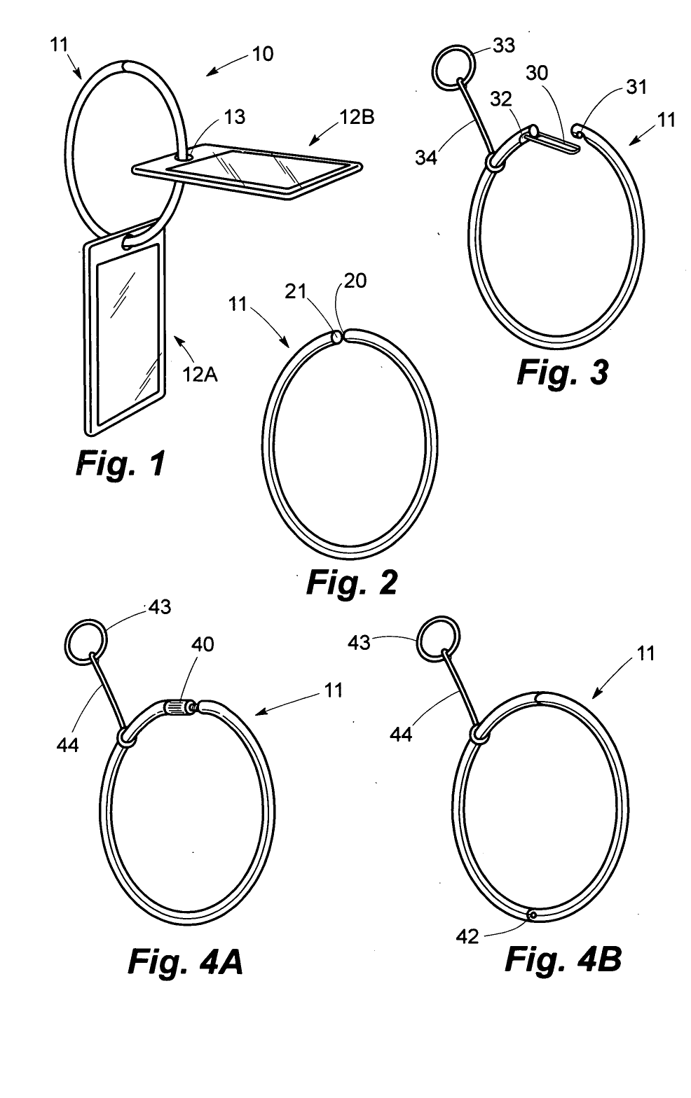

FIG. 1 shows an embodiment 10 for a business card holder according to the present invention comprising a loop 11 and a plurality of protective members 12, each member defining a hole 13 thereon so that each member can attach or hang from loop 11.

In the preferred embodiment, loop 11 can be manipulated to be adaptively open or closed. For example, in FIG. 2, the loop 11 has two ends 20 and 21, which normally abut each other and form a closed loop 11. When loop 11 is in a closed position, the plurality of the plastic members 12 are safely retained on the loop and can be rotated about the loop so that the user of the present invention can easily find and access a particular protective member 12 containing desired information. Loop 11 is generally circular; however, it can be shaped elliptical, oval or any desired shape as long as it can be used to retain a plurality of the protective members 12. Loop 11 can be made of metal, plastic, wood, or the like flexible and relatively hard material.

When the user wishes to add an additional protective member 12 containing a new business card, she determines the appropriate position for the additional protective member 12 and opens the loop 11 so that the additional protective member 12 can be inserted at the desired position. In the embodiment shown in FIG. 2, two ends 20, 21 can be forced apart, so that one end of the loop 11 can be slid through the hole defined by the protective member 12. Accordingly, the present invention eliminates the need to re-arrange accumulating business cards, which is often necessary when one uses a notebook with a plurality of divided, protective sheets. Furthermore, the present invention provides for space to store additional business cards, and its structure easily accommodates modular use. For example, a plurality of loops 11 can be used to provide ample storage space for and efficient organization of a number of business cards. (Discussed more in detail in connection with FIG. 8).

In another embodiment, loop 11 comprises an open-and-close means to allow the user to easily open and close the loop. In FIG. 3, loop 11 has lever 30, catch 31, and groove 32. Loop 11 can be opened using lever 30, and then the protective member 12 can be slid on loop 11. When catch 31 is placed on groove 32 and is locked using lever 30, the loop is in a closed position, which is the normal position for loop 11. In FIG. 3, loop 11 comprises a hanging element 33 having a chain 34 so as to facilitate the hanging of the loop 11 on devices such as hooks and nails. In FIG. 4a, loop 11 has a screw element 40 which allows the user to open the ring by turning the screw element one way and close the loop by turning the screw element in the opposite way. In FIG. 4b, a hinge 42 is used to facilitate opening and closing of loop 11. Various other devices, such as locking balls and latches, can be used as the open-and-close means.

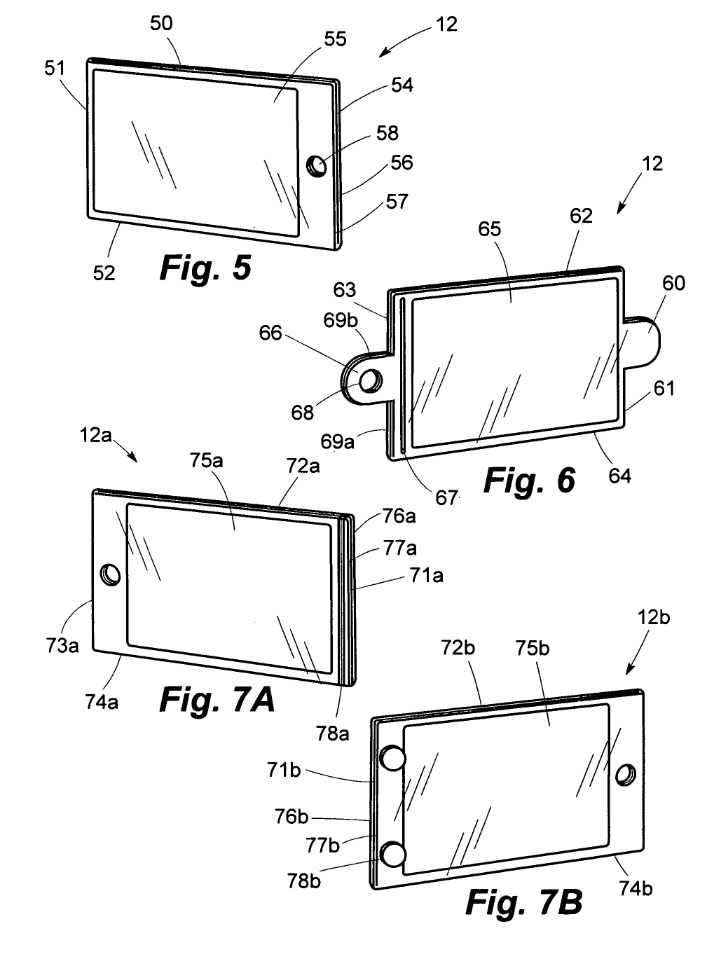

Protective member 12 comprises two sheets forming a protective cover for the business card 55 inserted therein. The two sheets are preferably made of plastic; however, any material that provides transparency and protection to the business card enclosed between the two sheets can be used. The protective member 12 is generally rectangular, but can be square or other desired shapes. In FIG. 5, three sides 50, 51 and 52 are closed permanently so that the business card 55 cannot slide and fall through any of them. Side 54 is open so that the card 55 can be slid into the space formed by sheets 56 and 57. Protective member 12 defines hole 58, which can be used to retain the protective member 12 on loop 11. Hole 58 can be defined on one or both of sheets 56 and 57. Alternatively, hole 58 can be defined on a protruding member attached to one side of the member as shown in FIG. 6. The color of sheets 56 and 57 is preferably clear so that the information on the business card 55 can be read through the sheets. The color of sheets 56 and 57 can also be tinted.

FIG. 6 illustrates another embodiment for the protective member 12. In this embodiment, the protective member 12 comprises two plastic sheets that form four closed sides, 61 through 64. Tab 60 is attached to side 61 so as to facilitate the organization of the plurality of business cards that can be accommodated on loop 11. Tab 60 can accommodate any indicia, including any alphanumeric or other desired notation. If preferred, tab 60 can also be attached to side 62. In FIG. 6, a second tab 66 protrudes from side 63 and defines a hole 68, which adaptively engages with loop 11. When hole 68 engages with loop 11, protective member 12 is attached or retained on loop 11. In FIG. 6, slit 67 is defined on one of the sheets 69a or 69b, so as to allow business card 65 to slide into the space formed between plastic sheets 69a and 69b.

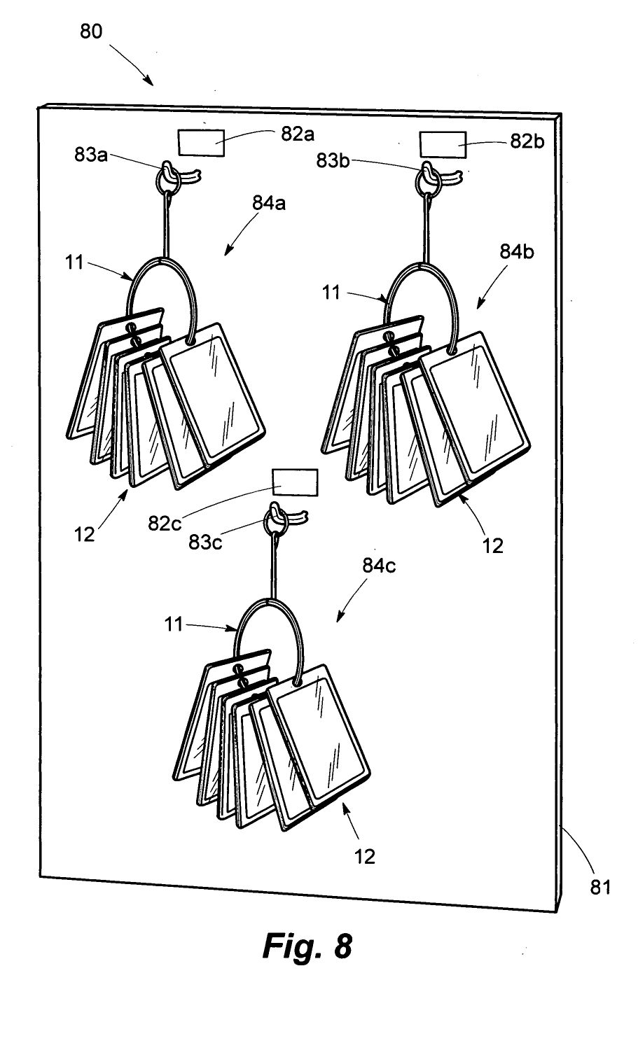

FIGS. 7a and 7b illustrate yet another embodiment for protective member 12. In this embodiment, two sheets of plastic form a protective cover for business card 75 and comprises three closed sides, 72, 73 and 74, and one side 71 that can be adaptively opened or closed. In particular, along the side 71 a locking-and-opening means, which is employed to allow a user to open apart sheets 76 and 77 when she wishes to insert or pull out business card 75. In normal use, sheets 76 and 77 are closed together to retain the business card 75 inside protective member 12. Locking-and-opening means can be such well known mechanism as a zip-lock 78a or a snap button device 78b.

FIG. 8 illustrates an embodiment 80 comprising a board 81, a plurality of indicia 82 and a plurality of hanging hooks 83. The hanging hooks are spaced apart so as to be aesthetically pleasing and accommodate a plurality of devices 84, each comprising a loop 11 and a plurality of plastic members 12. The embodiment shown in FIG. 8 allows a user to keep, for example, business cards relating to one type of business on one loop, a second type of business on a second loop, and etc.

Numerous modifications to and alternative embodiments of the present invention will be apparent to those skilled in the art in view of the foregoing description. Accordingly, this description is to be construed as illustrative only and is for the purpose of teaching those skilled in the art the best mode of carrying out the invention. Details of the embodiment may be varied without departing from the spirit of the invention, and the exclusive use of all modifications which come within the scope of the appended claims is reserved.

1. A holder for a business card, comprising:
a single loop having two ends and a protective member comprised of two sheets of transparent material, the protective member having a first side via which the business card can be inserted between the two sheets of transparent material, and the protective member defining a hole so that the protective member may be retained on the loop by sliding one of the two ends of the loop through the hole.

2. The holder according to claim 1, wherein the two sheets are made of plastic.

3. The holder according to claim 1, wherein the protective member comprises a tab attached to a second side such that a notation can be placed on the tab and facilitate retrieval of information on the business card retained within the protective member.

4. The holder according to claim 1, wherein the loop comprises an open-and-close means to facilitate opening and closing of the two ends of the loop.

5. The holder according to claim 1, wherein the loop comprises a catch, a lever and a groove to facilitate opening and closing of the two ends of the loop.

6. The holder according to claim 1, wherein the loop comprises a screw device to adaptively connect and disconnect the two ends of the loop.

7. The holder according to claim 1, wherein the loop comprises a hinge to facilitate opening and closing of the two ends of the loop.

8. The holder according to claim 1, wherein the protective member further comprises a protruded tab on the first side and the protruded tab defining the hole.

9. The holder according to claim 1, wherein the first side can be adaptively opened or closed.

10. The holder according to claim 1, wherein the first side defines a slit via which the business card may be inserted between the two sheets of transparent sheets.

11. The holder according to claim 1, wherein the protective member comprises a tab attached to the first side such that a notation can be placed on the tab and facilitates retrieval of information on the business card retained within the protective member.

12. A holder for a business card, comprising:
a loop having two ends, a protective member comprising two sheets of transparent material and a first side that can be adaptively opened or closed so that the business card can be inserted between the two sheets of transparent material and then retained within the protective member subsequent to the insertion, and a protruding element attached to a second side of the protective member, said protruding member defining a hole so that a protective member may retained on the loop by sliding one end of the loop through the hole.

13. The holder according to claim 12, wherein the loop comprises an open-and-close means to facilitate the opening and closing of the loop.

14. The holder according to claim 12, wherein the first side comprises a zip-lock device.

15. The holder according to claim 12, wherein the first side comprises a snap button device.

16. A holder for a business card, comprising:
a protective member being generally rectangular, having four sides, and comprising two sheets of transparent material, said protective member defining a hole near one of the four sides and said protective member having a side that can be adaptively opened or closed; and
a loop having two ends; wherein the protective member may be retained on the loop by sliding one of the two ends of the loop via the hole and wherein the business card may be inserted between the two sheets of transparent material via the side that can be adaptively opened or closed.

16. The holder according to claim 15, wherein the side that can be adaptively opened or closed comprises a zip-lock device.

17. The holder according to claim 15, wherein the side that can be adaptively opened or closed comprises a snap button device.

18. The holder according to claim 15, wherein the loop comprises an open-and-close means between the two ends of the loop.
